(19) United States
(12) Patent Application Publication
(10) Pub. No.: US 2016/0128342 A1
(43) Pub. Date: May 12, 2016

(54) Whole Grain Pancakes and Waffles

(71) Applicant: GENERAL MILLS, INC., Minneapolis, MA (US)

(72) Inventors: Candace Homco-Ryan, Shakopee, MN (US); Kristi Bahe, Coon Rapids, MN (US)

(73) Assignee: General Mills, Inc., Minneapolis, MN (US)

(21) Appl. No.: 14/897,546

(22) PCT Filed: Jun. 12, 2013
(86) PCT No.: PCT/US2013/045339

§ 371 Date: Dec. 10, 2015

(51) Int. Cl. A21D 10/04; A21D 13/02; A21D 13/00

(52) U.S. Cl. CPC A21D 10/04; A21D 13/0077; A21D 13/02

(57) ABSTRACT

Whole grain pancake and waffle batters may include whole grain wheat flour and one or more of whole grain brown rice flour and whole grain millet flour. Pancakes and waffles prepared from such batters may be considered as having a high nutritional density as a result of including whole grain flours.

### BACKGROUND

Many commercial establishments serve breakfast items such as pancakes and waffles. In some cases, commercial establishments serve pancakes and waffles that are previously prepared and frozen for subsequent re-heating by the commercial establishment. Similar heat-and-serve products may also be used by non-commercial establishments due to the convenience of these products.

It may be desirable to increase the nutritional content, such as the whole grain content, of these prepared pancakes and waffles. Grain kernels, prior to being ground into flour, include a fibrous exterior shell referred to as bran, an interior starch portion called the endosperm, and a nutrient-rich core called the germ. A whole grain flour product utilizes the entire grain kernel, i.e., the bran, the endosperm and the germ.

Whole grain wheat flour may be the sole whole grain source in many prepared pancake and waffle products. However, including a large amount of whole grain wheat flour content can result in a decrease in product desirability. For example, an increased whole grain wheat flour content can decrease the desirability of the batter as well as the resulting cooked pancake or waffle product. Accordingly, there is an ongoing desire to provide batters and cooked products, such as frozen pancakes and waffles, that provide increased levels of whole grains while maintaining the desired taste, texture and other organoleptic qualities of the product as compared to previously available non-whole grain or lower whole grain content products.

### SUMMARY

The present invention relates to pancake and waffle batters and to pancakes and waffles prepared from the batters. Pancakes and waffles may be considered as having a high nutritional density as a result of including whole grain flours.

In some embodiments, a composition includes about 20% to about 38% by weight whole grain wheat flour, about 4.5% to about 21.5% by weight whole grain rice brown flour, millet flour or combinations thereof, about 40% to about 50% by weight water, about 3% to about 17% by weight sugar and about 2% to about 7% by weight fat. The composition may have a Bostwick value of 5 to 11 cm measured after 30 seconds at a temperature ranging from 4.4 to 12.8° C.

In another embodiment, a cooked pancake or waffle includes 20 to 38 grams whole grain wheat flour, 4.5 to 21.5 grams whole grain rice brown flour, millet flour or combinations thereof, 3 to 17 grams sugar and 2 to 7 grams fat. The cooked pancake has 35-47% whole grain by weight of the cooked pancake or waffle. It will be appreciated that these numbers are scalable, i.e., a relatively smaller product will have relatively smaller amounts of these ingredients while a relatively larger product will have relatively larger amounts of these ingredients.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE FIGURES

FIG. 1 is an exemplary plot of a texture analysis of a cooked pancake.

### DETAILED DESCRIPTION

The current invention relates to whole grain pancake and waffle batters and batter compositions as well as the corresponding cooked pancakes and waffles. In some embodiments, whole grain pancakes and waffles can be cooked and then frozen for subsequent delivery to commercial establishments such as schools, hospitals and the like and/or to consumers. The frozen whole grain pancakes and waffles can be reheated and served. The frozen whole grain pancakes and waffles are stable during freezer storage and can be re-heated to provide a high grain content, tasty pancake or waffle.

In some embodiments, a pancake or waffle batter can include a whole grain flour mixture, water, sugar and fat. The whole grain flour mixture includes whole grain wheat flour and at least one of whole grain brown rice flour, whole grain millet flour and combinations thereof. The batter can include minor components such as lecithin, egg solids, leavening system, milk solids and the like.

A whole grain kernel, prior to being ground into flour, include a fibrous exterior shell referred to as bran, an interior starch portion called the endosperm, and a nutrient-rich core called the germ. As referenced herein, a whole grain flour may describe flour that is formed by grinding entire kernels of a whole grain into flour. A whole grain flour may also include a composition in which the bran, endosperm and germ were separately processed or ground and the processed portions were recombined. In some embodiments, the recombined whole wheat flour composition may have the same ratio of bran, endosperm and germ as would result from processing the kernels as a whole.

The whole grain wheat flour may comprise the majority of the whole grain flour of the pancake or waffle batter. In some embodiments, a pancake or waffle batter may include whole grain wheat flour in an amount ranging from about 20% to about 38% by weight of the batter, and more preferably from about 20.4% to about 37.3%. In some embodiments, a pancake or waffle batter that includes less than about 20% by weight whole grain wheat flour may result in an excessively thin or runny batter. In some embodiments, a pancake or waffle batter that includes more than about 38% by weight whole grain wheat flour may result in an excessively thick batter as whole grain wheat flour tends to absorb water.

In some embodiments, a pancake or waffle batter may include one or more whole grain flours in addition to whole grain wheat flour, such as whole grain brown rice flour, millet flour and combinations thereof. Adding the second whole grain flour may increase the total grain content of the resulting pancake or waffle while providing an enjoyable product. Suitable amounts of the second whole grain flour include from about 4.5% to about 21.5% by weight of the batter. In some embodiments the batter may include from about 10.5% to about 21.5% brown rice flour. In other embodiments the batter may include from 4.5% to 10.5% millet flour by weight.

In some embodiments, a pancake or waffle batter that includes less than about 4.5% by weight whole grain brown rice flour may not provide a desired whole grain content, depending on what other whole grains are included. In some embodiments, a pancake or waffle batter that includes more than about 21.5% by weight whole grain brown rice flour may result in a final cooked product that becomes grainy.

In some embodiments, a pancake or waffle batter that includes less than about 4.5% by weight whole grain millet flour may not provide a desired whole grain content, depending on what other whole grains are included. In some embodiments, a pancake or waffle batter that includes more than about 21.5% by weight whole grain millet flour may result in a final cooked product that is too dry and/or a batter that is too thin.

The pancake or waffle batter also includes water. The water content affects the texture and consistency of the batter. In some embodiments, suitable amounts of water include amount ranging from about 40% by weight to about 50% by weight of the batter, and more preferably from about 42% to about 46%. In some embodiments, a pancake or waffle batter that includes less than about 40% by weight water may be too viscous to properly handle, such as dispensing the batter onto a griddle or other cook surface. In some embodiments, a pancake or waffle batter that includes more than about 50% by weight water may be too thin, and may spread too far when cooking.

In some embodiments, a pancake or waffle batter includes sugar in an amount from about 3% to about 17% by weight of the batter, and more preferably from about 5% to about 15%. Useful sugars include saccharides such as monosaccharides and disaccharides. Monosaccharides typically have 5 or 6 carbon atoms, and have the general empirical formula Cₙ(H2O)ₙ. Disaccharides consist of two monosaccharides joined together with the concomitant loss of a water molecule. Illustrative but non-limiting examples of suitable sugars include pentoses such as fructose, xylose, arabinose, glucose, galactose, amylose, fructose, sorbose, lactose, maltose, dextrose, sucrose, maltodextrins, high fructose corn syrup (HFCS), molasses and brown sugar. In some embodiments, honey may be used as a sweetener.

In some embodiments, the sucrose source may affect the color and flavor (i.e., sweetness) of the cooked product. For example, in some embodiments, the inclusion of brown sugar may produce a darker cooked product as compared to a product in which all or a portion of the brown sugar is substituted with granulated white sugar. Sucrose is present to provide sweetness to the batter.

The pancake or waffle batter includes from about 2% to about 7% by weight fat, and more preferably from about 5.5% to about 6.5%. Suitable fats include oils such as cottonseed oil, nut oil, soybean oil, sunflower oil, rapeseed oil, sesame oil, olive oil, corn oil, safflower oil, palm oil, palm kernel oil, coconut oil, and combinations thereof. Solid fats, such as butter, may also be suitable. In some embodiments, the fat may affect the spread of the dough during cooking. For example, in some embodiments, the inclusion of less than 3% fat may result in a cooked product that has an insufficient amount of spread, is difficult to handle, and that is dry, while too much fat may result in a cooked product that is undesirably soft.

The pancake or waffle batter may include a chemical leavening system. A chemical leavening system may include an acid and a base that can react to form carbon dioxide. Suitable leavening systems may include baking soda (sodium bicarbonate or potassium bicarbonate), monocalcium phosphate monohydrate (MCP), monocalcium phosphate anhydrous (AMCP), sodium acid pyrophosphate (SAPP), sodium aluminum phosphate (SALP), dicalcium phosphate dihydrate (DPD), dicalcium phosphate (DCP), sodium aluminum sulfate (SAS), glucono-deltalactone (GDL), potassium hydrogen tartrate (cream of tartar), and the like.

Baking soda is a leavening base and is the primary source of carbon dioxide in many chemical leavening systems. This compound is stable and relatively inexpensive to produce. Baking soda can be used in either an encapsulated form or in a non-encapsulated form. Use of an encapsulated baking soda delays the onset of the leavening reaction as the encapsulating material must first be dissolved before the leavening reaction can occur. In some embodiments, the batter may include from about 0.1% to about 0.8% of a leavening system, such as baking soda, by weight. In some embodiments, the batter may include baking powder in an amount from about 0.1% to about 0.8% by weight of the batter.

In some embodiments, the pancake or waffle batter may include egg solids. Suitable sources of egg solids include whole eggs (albumen and yolk) and dried whole eggs. Egg whites and dried egg whites may also be used. The egg solids also contribute structure to the batter. More specifically, the proteins of the eggs solids provide a matrix or bind the ingredients together to form a suitable batter. In some embodiments, whole dried egg may be present in an amount from about 0.2% to 1.2% by weight of the batter, and more preferably from about 0.5% to about 1%.

In some embodiments, the pancake or waffle batter may include milk solids. Suitable sources of milk solids include dried milk. In some embodiments, milk solids may be present in an amount from about 0.3% to about 3% by weight of the batter, and more preferably from about 1% to about 2%.

In some embodiments, the pancake or waffle batter may include lecithin. Lecithin may function as a release agent such that the cooked product is more easily released from the cooking surface. Additionally or alternatively, lecithin may function to thicken or emulsify the batter. Suitable sources of lecithin include soy lecithin having a total fatty acid (FTA) content of less than 2% by weight. In some embodiments, a batter in accordance with the present invention includes lecithin in an amount ranging from about 0.3% to about 3% by weight of the batter, and more preferably from about 0.4% to about 1%.

In some embodiments, the batter may include one or more antimycotic agent(s) to enhance microbial stability. Useful agents include sorbic acid and its derivatives such as sodium or potassium sorbate, propionic acid and its derivatives, vinegar, sodium diacetate, monocalcium phosphate, lactic acid, citric acid and the like. These agents are present in an amount effective to inhibit the growth of undesired yeast and/or molds, typically in amount from about 0.1% to about 0.2% by weight of the batter. Too little will not provide sufficient antimycotic effect, while too much can impart an off taste to the batter.

In addition to the foregoing, other ingredients known to those of skill in the art can be included in the compositions to give a variety of desired properties, flavors and/or textures. Examples of these ingredients include flavoring and coloring agents, flavors, such as vanilla flavor, butter flavor, spices, such as salt, flavor identifying particulates such as fruit, chocolate, or nuts, and the like. Suitable amounts of flavoring and coloring agents, flavors and spices include 0.1-3% by weight of the batter.

The batters described herein may have improved properties as compared to batters formed with same amount of whole grain content provided entirely by whole grain wheat flour. The batters described herein may also have properties similar to those of batters formed with non-whole grain flours, such as enriched wheat flour. That is, the batters described herein which include brown rice flour, millet flour and combinations thereof as a source of whole grain in addition to whole grain wheat flour have improved properties as compared to batters with the same whole grain content provided entirely by whole grain wheat flour and are more similar to batters formed with non-whole grain flours.

The batters described herein achieve a whole grain content of at least 35% by weight of the batter by the inclusion of whole grain brown rice and/or millet flour. It is believed that the starch of whole grain brown rice flour does not hydrate as quickly as that of whole grain wheat flour, thus, producing a batter and cooked product with improved properties. It is believed that the hydration of whole grain millet flour is also different than that of whole grain wheat flour and may be similar to that of whole grain brown rice flour.

The thickness of the batter affects the ease with which the batter may be formed into or cooked into a pancake or waffle. There are a variety of ways to determine if a batter is too thin or too thick. In some embodiments, the thickness of a pancake or waffle batter can be determined using a consistometer. A consistometer is a device that includes a flat surface having a graduated scale and a reservoir to hold a predetermined amount of the material to be tested. A spring-loaded gate can be opened, allowing the material to flow out of the reservoir and over the flat surface having the graduated scale. By measuring how far the material flows in a particular time period, an indication of thickness can be obtained. In some embodiments, the consistometer can be a Bostwick Consistometer available commercially from www.endecotts.com.

The values provided by the consistometer are distances, i.e., how far down the flat surface the tested material flowed. In some embodiments, a pancake or waffle batter in accordance with the present invention has a Bostwick value that ranges from about 5 cm to about 11 cm. A batter having a Bostwick value that is less than about 5 cm may be too thick to accurately dispense onto a griddle or cooking surface, while a batter having a Bostwick value that is greater than about 11 cm may be too thin and may run into adjacent pancakes or waffles. In some instances, an excessively thin batter can flash when subjected to a hot griddle or other cooking surface.

Exemplary pancake and waffle batter compositions are provided in Tables 1 and 2. Table 3, and Table 4, provides exemplary whole grain flour mixtures for inclusion in the batter compositions. All components in Table 1, Table 2, Table 3 and Table 4 are provided as weight percent of the batter.

TABLE 1
Pancake Batter Composition

| | Range (% by weight of | Range (% by weight of |
|---|---|---|
| | batter) | batter |
| Whole grain flour | 40-50 | 40-50 |
| mixture | | |
| Water | 40-50 | 42-46 |
| Sugar | 7-17 | 9-15 |
| Fat | 2-7 | 5.5-6.5 |

TABLE 2
Waffle Batter Composition

| | Range (% by weight of | Range (% by weight of |
|---|---|---|
| | batter) | batter) |
| Whole grain flour | 40-50 | 40-50 |
| mixture | | |
| Water | 40-50 | 42-46 |
| Sugar | 7-17 | 9-15 |
| Fat | 2-7 | 5.5-6.5 |
| Lecithin | 0.3-3 | 0.4-1 |

TABLE 3
Whole Grain Wheat/Brown Rice Flour Mixture

| | Range (% by weight of | Range (% by weight of |
|---|---|---|
| | batter) | batter) |
| Whole grain wheat | 20-38 | 20.4-37.3 |
| flour | | |
| Whole grain brown rice | 4.5-21.5 | 10.5-21.5 |
| flour | | |

TABLE 4
Whole Grain Wheat/Millet Flour Mixture

| | Range (% by weight of | Range (% by weight of |
|---|---|---|
| | batter) | batter) |
| Whole grain wheat | 20-38 | 20.4-37.3 |
| flour | | |
| Whole grain brown rice | 4.5-21.5 | 10.5-21.5 |
| flour and/or millet flour | | |

The pancake and waffle batters may be cooked to form pancakes and waffles using a griddle or other heated surface. In some embodiments, pancakes can be cooked by ladling or otherwise dropping pancake batter onto a heated griddle or other cooking surface. In some embodiments, the pancake batter can be precisely measured and dropped onto the heated griddle using a dispensing device that is configured to dispense batter for a plurality of pancakes at essentially the same time. In one embodiment, each pancake may be formed from an amount of pancake batter that ranges from about 11 grams to about 13 grams. The griddle may be heated to a temperature that ranges from about 350° F. (about 177° C.) to about 400° F. (about 204° C.) and the pancakes may cook for a period of time that ranges from about 1.5 to about 2 minutes per side, 3-4 minutes total.

In some embodiments, waffles can be cooked by ladling or otherwise dropping waffle batter onto a lower plate of a waffle maker, and then sandwiched between the lower plate and an upper plate of the waffle maker. In some embodiments, the waffle batter can be precisely measured and dropped onto the waffle maker using a dispensing device that is configured to dispense batter for a plurality of waffles at essentially the same time. In one embodiment, each waffle may be formed from about 80 to about 100 grams of waffle batter. The waffle maker may be heated to a temperature that ranges from about 380° F. (about 193° C.) to about 420° F. (about 216° C.) and the waffles may cook for a period of time that ranges from about 2.5 to about 3.5 minutes.

In some embodiments, the cooked pancakes and waffles may be frozen and packaged for subsequent re-heating. In some embodiments, the cooked pancakes and waffles may be packaged into oven-safe packages so that the packaged pancakes and waffles can be re-heated by placing the packaged product into a suitable oven.

It will be appreciated that the batter undergoes compositional changes during cooking. For example, liquids, such as water, may evaporate from the batter during cooking. In some embodiments, it is estimated that 8-10% of the batter weight is lost due to evaporation during cooking. In some embodiments, the weight loss due to evaporation may be added back to the product after the cooking process. For example, the cooked pancake product may be sprayed with water prior to the freezing and packaging process. In some embodiments, the cooked pancake product may be sprayed with a sufficient amount of water to compensate for water or other weight lost during the cooking process. As used herein, the term “cooked product” can refer to the pancake or waffle after it has been initially cooked, but before it has been packaged and subsequently re-heated. In some embodiments, “cooked product” can refer to the pancake or waffle either before or after it has been rehydrated after the initial cooking process.

The relative amounts of whole grain wheat flour, whole grain brown rice flour, whole grain millet flour, sugar and fat once cooked are shown below in Table 5.

TABLE 5
Cooked pancake and waffle compositions

| | Grams | Grams |
|---|---|---|
| Whole grain wheat flour | 20 | 38 |
| Whole grain brown rice flour | 4.5 | 21.5 |
| or millet flour | | |
| Sugar | 3 | 7 |
| Fat | 3 | 8 |

In some embodiments, the cooked pancake or waffle has at least 35% whole grain (combined whole grain wheat, whole grain brown rice and millet flour) by weight of the cooked product. In some embodiments, the cooked pancake or waffle may be considered as having a nutritional density, defined as percent by weight whole grain by weight of cooked product, that is in the range of 35%-47%.

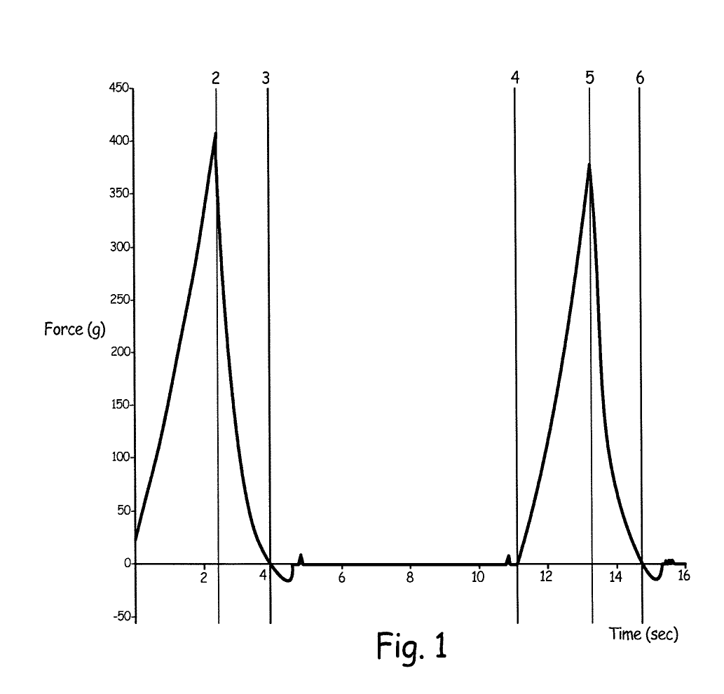

The batter compositions described herein provide a suitable cooked pancake or waffle product having a high whole grain content per gram of cooked product. For example, the cooked pancake or waffle product has suitable taste, texture and organoleptic properties. In some embodiments, the cooked products may be evaluated using texture analysis, which provides an indication of spreadability and hardness of the cooked product. During texture analysis, a cylinder is moved into the product to simulate a first bite. After a brief rest, the cylinder is moved into the product again to simulate a second bite. An exemplary plot from the texture analysis is illustrated in FIG. 1. As shown, the plot of force versus time includes a first curve representing the first bite and a second curve representing the second bite. The graphical data may be analyzed to provide information relating to the organoleptic quality of the sample.

Several properties that relate to the organoleptic quality of the pancake may be calculated from the texture analysis, including hardness, springiness, cohesiveness, and chewiness. Hardness is defined as the force required to compress a substance between the molars. Hardness is calculated as the peak force (in grams) of the first compression.

Springiness is an indication of the degree to which a product returns to its original shape once compressed. Springiness of the cooked product was calculated from the texture analysis as a ratio of the distance under the curve representing the second bite and the distance under the curve representing the first bite.

Cohesiveness is an indication of the degree to which a substance is compressed between the teeth before it breaks. Cohesiveness was calculated from the texture analysis as a ratio of the total area under the curve representing the first bite and the total area under the curve representing the second bite.

Chewiness is an indication of how long the substance needs to be chewed prior to swallowing. Chewiness is calculated from the texture analysis as the product of hardness, cohesiveness and springiness (chewiness=hardness×cohesiveness×springiness) and has units of grams.

In some embodiments, suitable cooked pancake and waffles have a hardness that ranges from about 270 to about 510 grams. In some embodiments, suitable cooked pancake and waffles have a springiness that ranges from about 0.62 to about 0.75. In some embodiments, suitable cooked pancake and waffles have a cohesiveness that ranges from about 0.55 to about 0.64. In some embodiments, suitable cooked pancake and waffles have a chewiness that ranges from about 100 to about 230 grams.

In some embodiments, the cooked products described herein may have improved properties (i.e., hardness, springiness, cohesiveness, and chewiness) as compared to products which have the same whole grain content but in which the only source of whole grain is whole grain wheat flour. Additionally, the cooked products described wherein may have properties more similar to that of products which do not include whole grain flours, such as products made with enriched wheat flour.

### EXAMPLES

The present invention is more particularly described in the following examples that are intended as illustrations only, since numerous modifications and variations within the scope of the present invention will be apparent to those of skill in the art. Unless otherwise noted, all parts, percentages, and ratios reported in the following examples are on a weight basis.

### Batter Viscosity Analysis

Using a Endecotts Standard Consistometer, Bostwick values were measured after a time of 30 seconds at a temperature that ranged from 40 to 55° F. (4.4-12.8° C.). In some embodiments, a suitable batter had a Bostwick value of 5 cm to 11 cm.

### Preparing Batter Compositions

Batter compositions were formed by adding wet ingredients to a Hobart 5 quart stainless steel bowl. The dry ingredients were added to the bowl and were mixed on speed 1 of the mixer for 60 seconds with a balloon whisk attachment (NSF 8). The sides of the bowl were scrapped down with a rubber spatula and the contents of the bowl were mixed for an additional 6 minutes on speed 2 of the Hobart mixer. The Hobart mixer used was a Hobart Model N50 operating at 100-120 volts, 60 Hz, 3.2 amps and at a maximum speed of 1725 rpm.

### Pancake Batters, Examples 1-5

A variety of pancake batters were prepared as described above. Table 6 provides the pancake batter composition.

In Examples 1-5, the total amount of whole grain flour was held constant at 41.8% by weight of the batter while relative amounts of whole grain wheat flour were varied. Each batter was tested for spread, as described above.

TABLE 6
Pancake batter composition

| | Percent by weight of |
|---|---|
| | the batter |
| Water | 44.19 |
| Whole grain flour composition (Table 7) | 41.80 |
| Granulated sugar | 5.61 |
| Oil | 5.72 |
| Whole egg dried free flowing | 0.22 |
| Nonfat dry milk | 0.2 |
| Flavors and spices | 0.79 |
| Leavening system | 0.98 |

TABLE 7
Pancake Batter Viscosity Analysis

| | Percent other | | | | |
|---|---|---|---|---|---|
| | whole grain | Percent whole | | | |
| | flour by weight | wheat flour by | | | |
| | of the batter | weight of the | Bostwick | | Temperature |
| | (flour/wt %) | batter | Value | | (° C.) |
| Example 1 | Brown rice 4.5 | 37.3 | 5 | cm | 7.67 |
| Example 2 | Brown rice 21.4 | 20.4 | 11 | cm | 7.72 |
| Example 3 | Millet 2 | 39.8 | 5 | cm | 9.61 |
| Example 4 | Millet 17 | 24.8 | 11 | cm | 9.56 |
| Example 5 | Millet 10.5 | 31.3 | 8.5 | cm | 10.28 |

As can be seen, in using brown rice flour in a pancake batter, a desirable Bostwick value of between 5 cm and 11 cm can be obtained using brown rice flour in an amount that ranges from 4.5% by weight to 21.4% by weight of the batter composition while the whole grain wheat flour correspondingly ranges from 37.3% by weight to 20.4% by weight of the batter composition. When using millet flour, a desirable Bostwick value can be obtained using millet flour in an amount that ranges from 2% by weight to 17% by weight of the batter composition while the whole grain wheat flour correspondingly ranges from 39.8% by weight to 24.8% by weight of the batter composition.

### Waffle Batter, Examples 6-9

In Examples 6-9, waffle batters were prepared as described above. Table 8 provides the pancake batter composition.

In Examples 6-9, the total amount of whole grain flour was held constant at 41.8% by weight of the batter while relative amounts of whole grain wheat flour were varied. Each batter was tested for spread, or viscosity as described above.

TABLE 8
Waffle batter composition

| | Percent by weight of |
|---|---|
| | the batter |
| Water | 44.66 |
| Whole grain flour composition (Table 8) | 41.80 |
| Granulated sugar | 5.61 |
| Oil | 5.72 |
| Whole egg dried | 0.22 |
| Nonfat dry milk | 0.20 |
| Flavors and spices | 0.79 |
| Leavening system | 0.98 |
| Lecithin fluid | 0.47 |

TABLE 9
Waffle Batter viscosity analysis

| | Percent other | | | | |
|---|---|---|---|---|---|
| | whole grain | Percent whole | | | |
| | flour by weight | wheat flour by | | | |
| | of the batter | weight of the | Bostwick | | Temperature |
| | (flour/wt %) | batter | Value | | (° C.) |
| Example 6 | Brown rice 2.9 | 38.9 | 5 | cm | 7.72 |
| Example 7 | Brown rice 20.4 | 21.4 | 11 | cm | 5.56 |
| Example 8 | Millet 2 | 39.8 | 5 | cm | 8.17 |
| Example 9 | Millet 17 | 24.8 | 11 | cm | 8.78 |

As can be seen, in using brown rice flour in a waffle batter, a desirable Bostwick value of between 5 cm and 11 cm can be obtained using brown rice flour in an amount that ranges from 2.9% by weight to 20.4% by weight of the batter composition while the whole grain wheat flour correspondingly ranges from 38.9% by weight to 21.4% by weight of the batter composition. When using millet flour, a desirable Bostwick value can be obtained using millet flour in an amount that ranges from 2% by weight to 17% by weight of the batter composition while the whole grain wheat flour correspondingly ranges from 39.8% by weight to 24.8% by weight of the batter composition.

### Examples 10, 11 and 12

Examples 10, 11 and 12 compared cooked batter compositions including whole grain wheat flour and whole grain flour compositions. The batter compositions are shown below in Table 10.

TABLE 10
Batter Compositions

| | Example 10 | Example 11 | Example 12 |
|---|---|---|---|
| | (wt %) | (wt %) | (wt %) |
| Whole grain wheat flour | 41.8 | 31.3 | 34.44 |
| Whole grain brown rice flour | — | 10.5 | |
| Water | 44.2 | 44.2 | 43.33 |
| Sugar | 5.61 | 5.61 | 8.41 |
| Soybean oil | 5.72 | 5.72 | 6.36 |
| Lecithin | 0.47 | 0.47 | 0.88 |
| Whole dried egg | 0.22 | 0.22 | 0.5 |
| Nonfat dry milk powder | 0.21 | 0.21 | 0.75 |
| Maltodextrin | — | — | 3.3 |
| Flavors and spices | 0.79 | 0.79 | 0.83 |
| Leavening system | 0.98 | 0.98 | 1.2 |

The batters for Examples 10, 11 and 12 were prepared as described above. Pancakes made from each of the batters were griddled, misted, blast frozen and packaged in a bakeable pouch. The next day, the pancakes were reheated in the pouch in a convection oven at 350° F. (177° C.) for 8 to 10 minutes. A stack of 3 mini pancakes were tested for texture using a texture analyzer having a female cylinder. Suitable texture analyzers are available from Stable Micro Systems, United Kingdom, and may be equipped with a TTC spreadability rig also available from Stable Micro Systems. A precisely-matching male cylinder was lowered into the sample, forcing the sample to flow upwards and outwards. The force required to move the male cylinder at a constant rate was measured. The measured force is an indication of the ease with which the sample flows, and the spreadability or hardness of the sample.

Table 11 below provides the test results for Examples 10, 11, and 12.

TABLE 11
Cooked pancake texture analysis

| | Example 10 | Example 11 | Example 12 |
|---|---|---|---|
| Hardness (grams) | 618.74 | 440.04 | 308 |
| Springiness | 0.779 | 0.732 | 0.66 |
| Cohesiveness | 0.679 | 0.621 | 0.57 |
| Chewiness (grams) | 327.303 | 199.688 | 116 |

As can be seen, the pancakes made from the batter containing both whole grain wheat flour and whole grain rice flour were softer (less hard) than those made with whole grain wheat flour only. The pancakes made from the batter containing both whole grain wheat flour and rice flour were less springy, less cohesive and less chewy than those made with whole grain wheat flour only.

Additionally, the texture analysis of the pancakes made from the batter containing both whole grain wheat flour and whole grain rice flour were more similar to pancakes made from batter containing 34% whole grain than to pancakes made from a batter containing 41.8% whole grain, in which the entire whole grain source was whole grain wheat.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

1. A composition comprising:
from 20% to 38% whole grain wheat flour by weight of the composition;
from 4.5% to 21.5% whole grain brown rice flour, whole grain millet flour or combinations thereof by weight of the composition;
from 40% to 50% water by weight of the composition;
from 3% to 17% sugar by weight of the composition; and
from 2% to 7% fat by weight of the composition,
wherein the composition has a Bostwick value of 5 cm to 11 cm measured after 30 seconds at a temperature ranging from 4.4 to 12.8° C.

2. The composition of claim 1, further comprising 0.3% to 3% lecithin by weight of the composition.

3. The composition of claim 1, further comprising one or more of egg solids or milk solids.

4. The composition of claim 1, further comprising a chemical leavening system.

5. The composition of claim 1, comprising about 4.5% to about 21.5% by weight whole grain brown rice flour.

6. The composition of claim 1, comprising about 4.5% to about 21.5% by weight whole grain millet flour.

7. The composition of claim 1, comprising from 20.4% to 31.3% whole grain wheat flour by weight of the composition.

8. The composition of claim 1, comprising 10.5% to 21.5% whole grain brown rice flour by weight of the composition.

9. The composition of claim 1, comprising 4.5% to 10.5% whole grain millet flour by weight of the composition.

10. A cooked pancake or waffle comprising:
20 to 38 grams whole grain wheat flour;
4.5 to 21.5 grams whole grain rice brown, whole grain millet flour or combinations thereof;
3 to 17 grams sugar; and
2 to 7 grams fat;
wherein the cooked pancake or waffle has at least 35% whole grain by weight of the cooked pancake or waffle.

11. The cooked pancake or waffle of claim 10, wherein the cooked pancake or waffle exhibits a hardness that is in the range of about 270 to about 510 grams.

12. The cooked pancake or waffle of claim 10, wherein the cooked pancake or waffle exhibits a cohesiveness that is in the range of about 0.55 to about 0.64.

13. The cooked pancake or waffle of claim 10, wherein the cooked pancake or waffle exhibits a springiness that is in the range of about 0.62 to about 0.75.

14. The cooked pancake or waffle of claim 10, wherein the cooked pancake or waffle exhibits a chewiness that is in the range of about 100 to about 230 grams.

15. The cooked pancake or waffle of claim 10, further comprising lecithin.

16. The cooked pancake or waffle of claim 10, further comprising one or more of egg solids or milk solids.

17. The cooked pancake or waffle of claim 10, further comprising a chemical leavening system.

18. The cooked pancake or waffle of claim 10, wherein the whole grain consists of whole grain wheat flour and whole grain brown rice flour.

19. The cooked pancake or waffle of claim 10, wherein the whole grain consists of whole grain wheat flour and whole grain millet flour.

20. The cooked pancake or waffle of claim 10, comprising 20.4 to 31.3 grams whole grain wheat flour.

21. The cooked pancake or waffle of claim 10, comprising 10.5 to 21.5 grams whole grain brown rice flour.

22. The cooked pancake or waffle of claim 10, comprising 4.5 to 10.5 grams whole grain millet flour.

23. The cooked pancake or waffle of claim 10, wherein the cooked pancake or waffle has 35%-47% whole grain by weight of the cooked pancake or waffle.
